(19) United States
(12) Patent Application Publication
(10) Pub. No.: US 2026/0292901 A1
(43) Pub. Date: Sep. 24, 2026

(54) BLE Pairing of a Mobile Device and a Motor Vehicle

(71) Applicant: Bayerische Motoren Werke Aktiengesellschaft, Muenchen (DE)

(72) Inventors: Thorsten KNOTT, Tuntenhausen (DE); Alaa MOURAD, Muenchen (DE)

(21) Appl. No.: 19/571,867

(22) Filed: Mar. 19, 2026

(30) Foreign Application Priority Data
Mar. 20, 2025 (DE) 10 2025 110 910.9

(51) Int. Cl. H04W 76/10; H04W 12/0431; H04W 12/69

(52) U.S. Cl. CPC H04W 76/10; H04W 12/0431; H04W 12/69

(57) ABSTRACT

A method for BLE pairing of a mobile device and a motor vehicle comprises steps of determining an identifier assigned to the motor vehicle; transmitting the identifier to the mobile device; broadcasting, from the motor vehicle, using BLE, a connection advertisement having the identifier; detecting, by means of the mobile device, using BLE, a connection advertisement having the identifier; transmitting, using BLE, a response from the mobile device to the connection advertisement; and BLE pairing the mobile device and the motor vehicle.

### CROSS REFERENCE TO RELATED APPLICATION

This application claims priority under 35 U.S.C. § 119 from German Patent Application No. 10 2025 110 910.9, filed Mar. 20, 2025, the entire disclosure of which is herein expressly incorporated by reference.

### BACKGROUND AND SUMMARY

The present invention relates to the controlling of a motor vehicle by means of a digital key stored on a mobile device. In particular, the invention relates to BLE pairing of the mobile device and the motor vehicle.

A motor vehicle can be secured by means of a design of a digital key, in particular according to the recommendations of the Car Connectivity Consortium (CCC). A cryptographic construct which serves as a digital key can be stored on a mobile device. A predetermined safety function of the motor vehicle, for example unlocking a vehicle door or vehicle gate or starting a drive motor, can be controlled after the digital key has been presented at the motor vehicle. The presentation takes place as part of a standard transaction or a fast transaction which are specified according to the recommendations of the CCC.

The described transactions can take place via various interfaces, including Bluetooth Low Energy (BLE). In order to use a BLE connection, the mobile device and the motor vehicle must first be paired using BLE. The motor vehicle usually transmits a connection advertisement with a fixed predetermined identifier 0xFFF5. The mobile device receives a connection advertisement and compares the identifier with the predetermined value 0xFFF5. If the received connection advertisement has the correct information, the mobile device responds and the mobile device and the motor vehicle can be paired. To do this, a user usually has to input an ID for the motor vehicle at a user interface of the mobile device.

If multiple ready-to-communicate motor vehicles are situated close to one another, pairing of a mobile device and one of the motor vehicles can be unsuccessful and different pairing can be attempted or performed. Subsequent use of a digital key, stored on the mobile device, for controlling a motor vehicle can then be unsuccessful.

One object on which the present invention is based is to provide an improved technique for BLE pairing of a mobile device and a motor vehicle. The invention achieves this object by means of the subject-matter of the independent claims. Dependent claims provide further embodiments and implementations.

According to a first aspect of the present invention, a method for BLE pairing of a mobile device and a motor vehicle comprises steps of determining an identifier assigned to the motor vehicle; transmitting the identifier to the mobile device; broadcasting, from the motor vehicle, using BLE, a connection advertisement having the identifier; detecting, by means of the mobile device, using BLE, a connection advertisement having the identifier; transmitting, using BLE, a response from the mobile device to the connection advertisement; and BLE pairing of the mobile device and the motor vehicle.

The method can be used in particular when a digital key is stored on the mobile device, on the basis of which the motor vehicle can be controlled. The key can be presented at the motor vehicle by predetermined cryptographic messages being exchanged via the Bluetooth Low Energy (BLE) connection. Two-way authentication between the motor vehicle and the mobile device can thus take place. The authentication preferably takes place on the basis of an asymmetric encryption method with a private key and a public key.

The mobile device can be assigned to an owner of the motor vehicle and the saved key can be used to control the motor vehicle in a predetermined fashion. In particular, on the basis of the key, a further key for the motor vehicle can be created and signed. A person to whom the key is assigned can act in the role of an owner of the motor vehicle.

In contrast to a known implementation, the identifier of the motor vehicle can be individual such that erroneous BLE pairing of the mobile device and a motor vehicle other than the one intended can be avoided. Should, for example, the BLE connection be established whilst the mobile device is situated in the region of multiple motor vehicles which are each broadcasting a connection advertisement, the mobile device can only respond to a connection advertisement which contains an identifier to which a digital key is assigned which is stored on the mobile device.

In some implementations, the identifier is assigned to a BLE interface of the motor vehicle. In particular, the identifier can be derived from an ID or a key which is used by the motor vehicle to communicate using BLE.

The identifier may be determined on the basis of an identity resolving key (IRK) of the BLE interface of the motor vehicle. The IRK is usually used to determine a resolvable private address (RPA). On this basis, only trustworthy devices can establish communication or pairing. Details about this can be found in the corresponding Bluetooth Low Energy specification.

In one embodiment, the identifier comprises the IRK and the BLE interface. The IRK has a length of 128 bits, whilst only 16 bits are provided for the identifier of the motor vehicle according to the applicable recommendations of the CCC. In one embodiment, predetermined bits of the IRK can therefore be mapped to bits of the identifier. In a simple embodiment, a predetermined portion of the IRK can be used as an identifier, for example the leading 16 bits. In a different embodiment, different portions of the IRK can be combined to form the identifier. The sequence of the portions in the IRK here does not have to correspond to the sequence in the identifier.

A BLE interface of the motor vehicle can comprise multiple transceivers. A transceiver is configured to broadcast (transmitter) and receive (receiver) electromagnetic signals. The transceivers can broadcast connection advertisements with the same IRK for a BLE connection. The mobile device can thus communicate with any transceiver in order to pair with the motor vehicle using BLE.

The identifier of the motor vehicle can be saved on a key server as part of owner pairing. As part of the owner pairing, a digital key for the motor vehicle is saved on the mobile device. The key is in particular assigned an owner role such that the key can be used to sign further digital keys for the motor vehicle. The key server plays a role in validating a new digital key for the motor vehicle. In particular, the key server can, on the basis of a digital key, create an attestation packet which is transmitted to the motor vehicle. The attestation packet and the digital key correspond to each other such that the digital key can only be used when the motor vehicle has received the attestation packet. In some implementations, the IRK is saved on the key server. The identifier can later be derived from the IRK at the key server or at the mobile device.

The identifier of the motor vehicle can be negotiated between the motor vehicle and the key server as part of the owner pairing. If valid owner pairing has not taken place, there is no valid identifier or no valid IRK at the key server. In this case, the method described herein can revert to a known method in which a fixed predetermined identifier is used instead of the identifier assigned to the motor vehicle. This identifier can in particular be 0xFFF5.

Information about the identifier can be transmitted to the mobile device as part of installing a digital key for the motor vehicle on the mobile device. This situation applies in particular when the digital key is not an owner key. In this case, communication between the mobile device and the key server can be made via an interface other than BLE, for example WLAN or NFC. The information about the identifier can be part of the digital key or be transmitted together with the digital key. In one embodiment, the identifier or the information about the identifier is transferred from the key server to the mobile device in encrypted form.

In some implementations, as part of owner pairing, communication between the motor vehicle and the mobile device is made by means of an interface other than the BLE interface. In particular, communication can be made using near field communication (NFC). Such an interface has an effective range of only a few centimeters such that the sensitive procedure of owner pairing requires the physical presence of the mobile device in the region of the motor vehicle. Misuse can thus be prevented in an improved fashion.

In a further variant of the present invention, the identifier or information about the identifier can be determined on the basis of a Bluetooth address. In particular, the address BD_ADDR can be used. Variants explained herein with regard to the IRK can be applied to the BD_ADDR.

According to a further aspect of the present invention, a control device for a motor vehicle comprises a BLE interface and a processing apparatus. The processing apparatus is configured to broadcast a connection advertisement with a predetermined identifier of the motor vehicle by means of the BLE interface; and to perform BLE pairing with a mobile device which responds to the connection advertisement.

According to yet another aspect of the present invention, a motor vehicle comprises a control device described herein. The motor vehicle can comprise in particular a motorcycle or an automobile.

According to a further aspect of the present invention, a mobile device comprises a BLE interface and a processing apparatus. The processing apparatus is configured to receive an identifier of the motor vehicle from an external location; to receive a connection advertisement having the identifier by means of the BLE interface; to respond to the connection advertisement; and to pair with the motor vehicle using BLE.

In particular, the processing apparatus can only pair using BLE with a motor vehicle which broadcasts a connection advertisement having an identifier which corresponds to an identifier which has previously been received from the external location. The external location can in particular comprise a key server. A digital key for controlling the motor vehicle can be registered on the mobile device. The saving or validating of the digital key can comprise communication with the external location or the key server.

The digital key is usually registered in a secure memory of the mobile device. In order to access the secure memory, it can be required that a person to whom the mobile device is assigned authenticates themselves with respect to the mobile device. This can be effected, for example, by presenting a biometric feature or by inputting a predetermined secret. The controlling of the motor vehicle can in this way be linked to the person.

According to yet another aspect of the present invention, a proposed system comprises a control device described herein and a mobile device described herein. In an alternative embodiment, the system comprises a motor vehicle described herein and the mobile device. The system can be configured to make controlling of the motor vehicle, in particular of a predetermined safety function of the motor vehicle, accessible only to a person to whom the mobile device is assigned.

The system or its constituent parts can advantageously be readily combined with recommendations made by the Car Connectivity Consortium for securing a motor vehicle by means of a digital key. A technical specification with the title “Car Connectivity Consortium Digital Key Technical Specification” has been published.

A processing apparatus described herein is preferably configured to partly or fully carry out a method described herein. For this purpose, the processing apparatus can be electronic and include, for example, an integrated circuit, a programmable logic chip, or a programmable microcomputer. The method can be implemented in the form of a configuration or as a computer program product having program code means for the processing apparatus. The configuration or the computer program product can be stored on a computer-readable data carrier. Features or advantages of the method can be transferred to the device or vice versa.

The invention will now be described in more detail with reference to the accompanying drawings, in which:

Other objects, advantages and novel features of the present invention will become apparent from the following detailed description of one or more embodiments and implementations when considered in conjunction with the accompanying drawings.

### BRIEF DESCRIPTION OF THE DRAWINGS

FIG. 1 illustrates a system;

FIG. 2 illustrates a flowchart of a method; and

FIG. 3 illustrates a flowchart of a further method

### DETAILED DESCRIPTION OF THE DRAWINGS

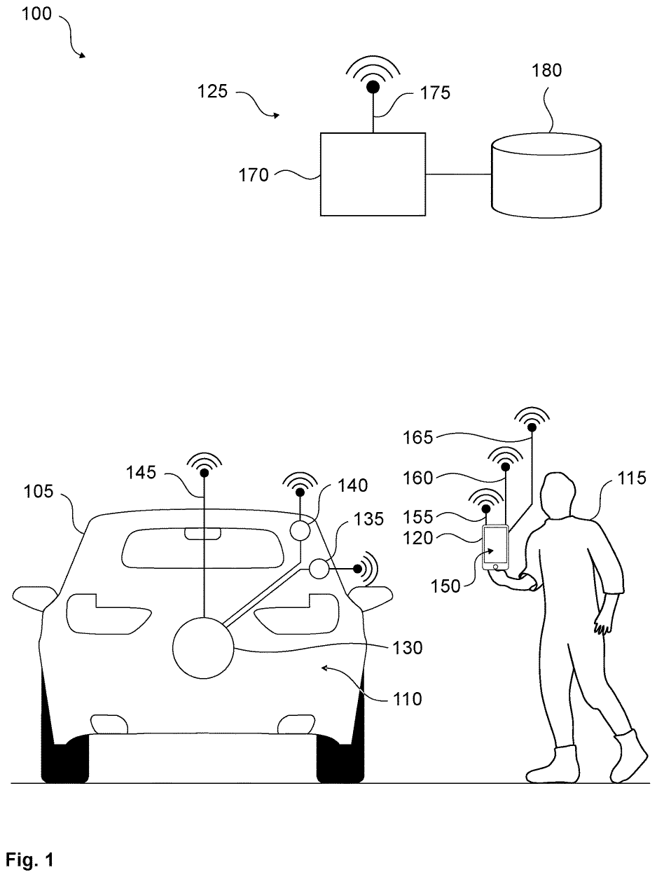

FIG. 1 shows system 100 with a motor vehicle 105. Attached on board the motor vehicle 105 is a device 110 which is configured to control a predetermined safety function of the motor vehicle 105, in particular with regard to entering or driving the motor vehicle 105. A mobile device 120 by means of which the safety function of the motor vehicle 105 can be controlled is assigned to a person 115. A cryptographic key which is required for this purpose can be generated or validated with the assistance of a key server 125.

The device 110 comprises a processing apparatus 130 which is connected to one or more interfaces. Purely by way of example, a BLE interface 135, an NFC interface 140, and a mobile radio interface 145 are provided.

Similarly, the mobile device 120 illustrated comprises a processing apparatus 150 which is connected to a BLE interface 155, an NFC interface 160, and a mobile radio interface 165. The interfaces 135 to 145 and 155 to 165 are in each case configured to establish a data connection to a corresponding location. In particular, data can be transmitted between the BLE interfaces 135 and 155 or the NFC interfaces 140 and 160. The mobile radio interfaces 145 and 165 can communicate with each other indirectly or directly. Moreover, communication with the key server 125 can be possible via them.

Not illustrated in FIG. 1 is a further interface which can be provided at the device 110 or the mobile device 120 and serves primarily for distance determination. This interface can in particular comprise an ultra-wideband (UWB) interface. Determining a distance between the motor vehicle 105 and the mobile device 120 can be part of an authentication method for controlling a safety function of the motor vehicle 105 by means of the mobile device 120.

The key server 125 preferably comprises a processing apparatus 170 which is connected to an interface 175 and an optional data memory 180. The interface 175 can in particular comprise a mobile radio interface to allow communication with the device 110 on board the motor vehicle 105 or the mobile device 120.

In order to control the safety function of the motor vehicle 105, a predetermined method for exchanging cryptographic keys between the device 110 and the mobile device 120 is usually performed. This preferably works on a BLE connection between the interfaces 135 and 155. In order to establish the BLE connection, BLE pairing between the devices 110 and 120 has to be performed. For pairing purposes, a connection advertisement which comprises a predetermined identifier of the motor vehicle 105 is broadcast by means of the device 110. According to the recommendations of the CCC, this identifier is set as fixed to the value 0xFFF5. The mobile device 120 first passively receives connection advertisements from surrounding devices. If a connection advertisement is received, the identifier assigned thereto is checked. If the connection advertisement contains a predetermined identifier, the value 0xFFF5 according to the recommendations of the CCC, the mobile device 120 responds and the device 110 and the mobile device 120 can perform BLE pairing.

It is proposed, instead of the fixed identifier, to use an identifier which relates in an improved fashion individually to the motor vehicle 105 or the device 110. This identifier can in particular be determined on the basis of an IRK which is specified as part of owner pairing between the device 110 on board the motor vehicle 105 and the key server 125 and is stored at the key server 125. The IRK has a length of 128 bits such that a clash with an IRK of another device in the region of the motor vehicle 105 is excluded in practice.

It has been recognized that BLE pairing of the device 110 and a mobile device 120 is expedient only when a digital key matching the motor vehicle 105 is stored on the mobile device 120. In order to store a valid or usable digital key in the mobile device 120, a creation or distribution method needs to be performed which requires communication between the mobile device 120 and the key server 125. It is proposed as part of this method to transmit the IRK registered in the key server 125 to the mobile device 120 and preferably to assign it to the digital key for the motor vehicle 105. In order to perform BLE pairing between the interfaces 135 and 155 of the devices 110 and 120, it is furthermore proposed that the device 110 broadcasts its connection advertisements on the basis of an identifier which is derived from the IRK in a predetermined manner. If the mobile device 120 receives a connection advertisement, an attached identifier can be compared with an identifier which is derived in the same way from the IRK which is supplied by the key server 125. If the identifiers correspond, the mobile device 120 can respond to the connection advertisement and the interfaces 135 and 155 can be paired using BLE. The BLE pairing can require assistance from the person 115, for example by requiring them to input a predetermined piece of information at the mobile device 120 which has been determined at the device 110 on board the motor vehicle 105.

It is usually only necessary to pair the devices 110 and 120 using BLE once. The devices 110, 120 can be made known to each other by the BLE pairing such that they can subsequently establish a communications connection between the interfaces 135 and 155 also automatically and in particular without the assistance of the person 115. The described exchange method can be performed via an established BLE connection in order to perform mutual authentication of the mobile device 120 and the device 110 on board the motor vehicle 105. If this authentication is successful, a predetermined safety function of the motor vehicle 105 can be controlled.

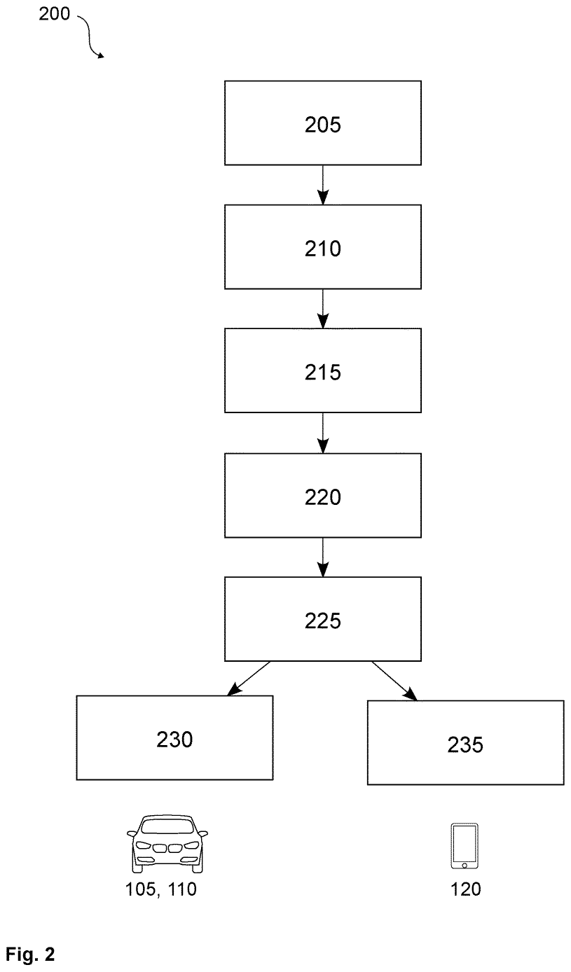

FIG. 2 shows a flowchart of an exemplary method 200. The method 200 constitutes a summary of owner pairing which is preferably performed according to the recommendations of the CCC. Details can be found in the published technical specification.

In a step 205, it can be determined that owner pairing needs to be performed. The owner pairing establishes a connection between a mobile device 120 and a motor vehicle 105. A digital key by means of which the motor vehicle 105 can be controlled and to which specific additional rights are assigned is here registered on the mobile device 120. In particular, on the basis of the owner key, a further digital key for the motor vehicle 105 can be created and signed and thus validated. The owner pairing is usually performed when the motor vehicle 105 changes owner. The safety requirements for the method 200 are accordingly high.

In a step 210, a communications connection can be established between NFC interfaces 140 and 160 of the device 110 or of the mobile device 120. A transceiver of the device 110 which converts electromagnetic waves into electric signals, and vice versa, is preferably situated in an interior of the motor vehicle 105. Because the range of an NFC connection is limited to a few centimeters, in order to perform the method 200, the mobile device 120 must be moved into the interior and sufficiently close to the transceiver. The mobile device 120 is usually laid on top of the transceiver of the device 110 or held against it.

In a step 215, proof of ownership can be provided. To do this, various alternatives are conceivable which can be selected in particular by a manufacturer of the motor vehicle 105. In one embodiment, at least two digital keys which have previously been issued to an owner of the motor vehicle 105 must be presented on board the motor vehicle 105. The digital keys can be stored, for example, on key cards or fobs. The presentation of a digital key preferably also takes place via the NFC interface 140 in the interior of the motor vehicle 105.

In a step 220, a cryptographic key by means of which the motor vehicle 105 is to be controlled later can be generated at the mobile device 120.

According to a predetermined method, in a step 225 the generated digital key can be signed at the key server 125 and thus validated. As part of the validation, in a step 230 a signed attestation packet can be transmitted to the motor vehicle 105. The transmission usually takes place via the mobile radio interface 145. Moreover, a message which contains the signed key of the mobile device 120 can be transmitted to the mobile device 120.

It is proposed that an IRK, which as part of the step 225 is created between the device 110 and the key server 125 and is stored at the key server 125, is transmitted in the step 235 to the mobile device 120.

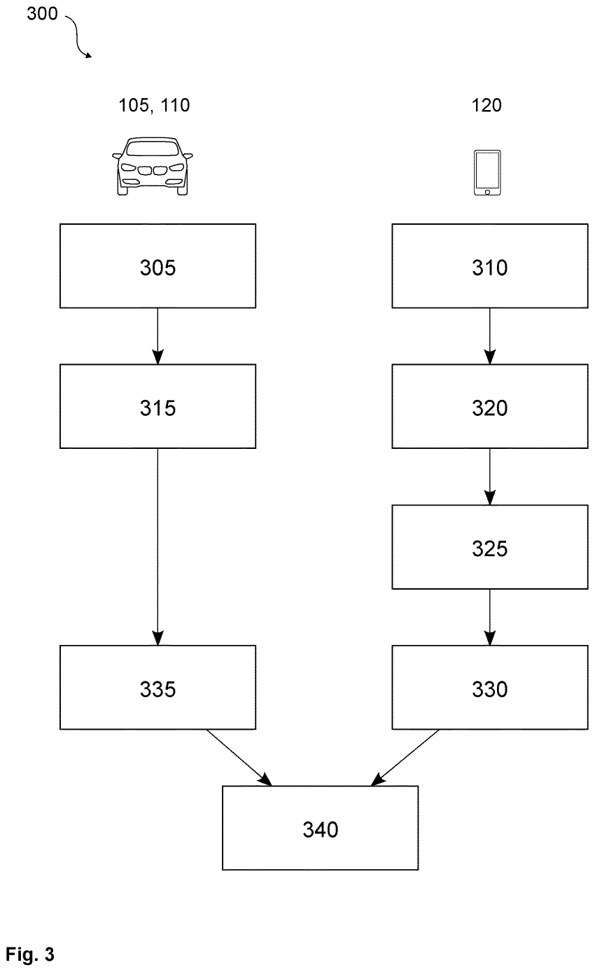

FIG. 3 shows a flowchart of a further method 300 for controlling a motor vehicle 105. The method 300 assumes that the method 200 has been performed successfully. In this sense, the methods 200 and 300 can also be understood as a single, continuous method.

In a step 305, an identifier can be determined at the motor vehicle 105 on the basis of the IRK which has previously been supplied to the key server 125 and stored there.

In a corresponding step 310, an identifier of the motor vehicle 105 can be determined at the mobile device 120, wherein the identifier has been received from the key server 125. In particular, the IRK can have been received at the mobile device 120 from the key server 125 as part of a key issuing or validating method for a digital key for controlling the motor vehicle 105.

In a step 315, a connection advertisement using the identifier determined at the device 110 is broadcast at the device 110 on board the motor vehicle 105. The broadcasting of the connection advertisement is also called advertising. In a step 320, the connection advertisement of the device 110 of the motor vehicle 105 is received at the mobile device 120.

In a step 325, it can be determined whether the received identifier corresponds to the identifier determined in the step 310. If it does, in a step 330 the mobile device 120 can respond to the connection advertisement and broadcast a corresponding message to the device 110 on board the motor vehicle 105. The response can be received at the device 110 in a step 335. If the devices 110, 120 agree with regard to the said and further exchanged parameters, BLE pairing can take place in a step 340.

It should be noted that the method 300 constitutes a modification of a method which is published in the technical specification of the digital key by the CCC, in particular in chapter 19. In this context, reference is made in particular to FIG. 19-1 which describes a flowchart of a method for BLE pairing of a mobile device 120 and a device 110 on board a motor vehicle 105. Reference is also made to a table 19-2 in which an identifier of the motor vehicle, referred to as a UUID, is provided with a fixed predetermined value. As part of the present art, it is proposed not to use a static value for the UUID and instead a dynamically determined value.

Following the method 300, a transaction can be conducted in order to check the validity of a cryptographic key registered at the mobile device 120 by means of communication between the BLE interfaces 135 and 155. If the check is successful, a predetermined safety function of the motor vehicle 105 can be controlled when requested by the mobile device 120.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### Reference Signs

100 system
105 motor vehicle
110 device
115 person
120 mobile device
125 key server
130 processing apparatus
135 BLE interface
140 NFC interface
145 mobile radio interface
150 processing means
155 BLE interface
160 NFC interface
165 mobile radio interface
170 processing means
175 interface
180 data memory
200 method
205 start owner pairing
210 pair mobile device to motor vehicle using NFC
215 provide proof of ownership
220 generate key on mobile device
225 validate key
230 signed attestation packet at motor vehicle
235 signed key at mobile device
300 method
305 determine identifier on the basis of IRK
310 determine identifier
315 broadcast connection advertisement having identifier
320 receive connection advertisement
325 does received identifier correspond to determined identifier?
330 respond to connection advertisement
335 receive response
340 pair

What is claimed is:

1. A method for Bluetooth Low Energy (“BLE”) pairing of a mobile device and a motor vehicle, the method comprising:
determining an identifier assigned to the motor vehicle;
transmitting the identifier to the mobile device;
broadcasting, from the motor vehicle, using BLE, a connection advertisement having the identifier;
detecting, by means of the mobile device, using BLE, a connection advertisement having the identifier;
transmitting, using BLE, a response from the mobile device to the connection advertisement; and
BLE pairing of the mobile device and the motor vehicle.

2. The method according to claim 1, wherein the identifier is assigned to a BLE interface of the motor vehicle.

3. The method according to claim 2, wherein the identifier is determined on the basis of an identity resolving key (“IRK”) of the BLE interface.

4. The method according to claim 2, wherein the identifier comprises a predetermined portion of the IRK.

5. The method according to claim 3, wherein the BLE interface at the motor vehicle comprises multiple transceivers which broadcast connection advertisements with the same IRK for a BLE connection.

6. The method according to claim 1, wherein the identifier is saved on a key server as part of owner pairing.

7. The method according to claim 6, wherein the identifier is negotiated between the motor vehicle and the key server as part of the owner pairing.

8. The method according to claim 1, wherein information about the identifier is transmitted to the mobile device as part of installing a digital key for the motor vehicle on the mobile device.

9. The method according to claim 1, wherein communication between the motor vehicle and the mobile device as part of the owner pairing is made by means of an interface other than the Bluetooth interface.

10. The method according to claim 1, wherein the identifier is determined on the basis of a Bluetooth address BD_ADDR.

11. A control device for a motor vehicle, comprising:
a Bluetooth Low Energy (“BLE”) interface;
a processing apparatus configured to:
broadcast a connection advertisement with a predetermined identifier of the motor vehicle by means of the BLE interface; and
perform BLE pairing with a mobile device which responds to the connection advertisement.

12. A motor vehicle comprising a control device according to claim 11.

13. A mobile device, comprising:
a Bluetooth Low Energy (“BLE”) interface;
a processing apparatus configured to:
receive an identifier of the motor vehicle from an external location;
receive a connection advertisement having the identifier by means of the BLE interface;
respond to the connection advertisement; and
pair with the motor vehicle using BLE.

14. A system, comprising:
a control device for a motor vehicle, comprising:
a Bluetooth Low Energy (“BLE”) interface;
a processing apparatus configured to:
broadcast a connection advertisement with a predetermined identifier of the motor vehicle by means of the BLE interface of the control device; and
perform BLE pairing with a mobile device which responds to the connection advertisement; and
the mobile device, comprising:
a Bluetooth Low Energy (“BLE”) interface;
a processing apparatus configured to:
receive an identifier of the motor vehicle from an external location;
receive a connection advertisement having the identifier by means of the BLE interface of the mobile device;
respond to the connection advertisement; and
pair with the motor vehicle using BLE.
